(19) United States
(12) Patent Application Publication
(10) Pub. No.: US 2012/0162669 A1
(43) Pub. Date: Jun. 28, 2012

(54) IMAGE FORMING APPARATUS

(75) Inventor: Ken MIYAZAKI, Sagamihara-shi (JP)

(73) Assignee: Konica Minolta Business Technologies, Inc., Tokyo (JP)

(21) Appl. No.: 13/335,215

(22) Filed: Dec. 22, 2011

(30) Foreign Application Priority Data
Dec. 22, 2010 (JP) 2010-285362

(51) Int. Cl. G06K 15/02

(52) U.S. Cl. 358/1.2

(57) ABSTRACT

An image forming apparatus including: a density-correction-data generation unit generating density correction data by causing the sensor to read a density correction chart formed on the sheet by an image forming unit; a storage unit storing the generated density correction data in connection with a sheet type; a density correction unit reading the density correction data corresponding to the sheet type used for printing from the storage unit, and making density correction of image data to be printed based on the density correction data; an image stabilization control unit performing image stabilization control for adjusting process conditions of the image forming unit; and a regeneration control unit controlling the density-correction-data generation unit to regenerate the density correction data stored in the storage unit if the image stabilization control is performed.

### BACKGROUND OF THE INVENTION

1. Field of the Invention

The present invention relates to an image forming apparatus.

2. Description of Related Art

A conventional image forming apparatus involves image stabilization control for adjusting process conditions to supply stable images regardless of changes in environments such as humidity or temperature and temporal changes in photoreceptors and developing unit, for example, in an image forming apparatus. For example, Patent Literature 1 discloses a technique for adjusting in advance adjustment items predicted to be adjusted during the next job to prevent adjustment during the job (see Patent Literature 1: Japanese Patent Application Laid-Open No. 2004-142250).

Image processing in the image forming apparatus includes a density correction for reducing the influence of characteristics inherent in the image forming apparatus and forming color images faithful to input images on sheets. An example of the density correction is printer γ correction (printer gamma correction). The “printer γ correction” refers to an adjustment of a relation between input values such as a density or brightness of an input image input to the image forming apparatus and output values such as the density of an image actually formed on a sheet on the basis of the input image. As is disclosed in, for example, Patent Literature 2, color patches are output from an image output unit based on color patch data stored in a color patch memory, an image input unit reads the output color patches, and the read color patch data is compared with that stored in the color patch memory and cancelling the difference to create a γ correction table (gamma correction table). Using this γ correction table, input image data is corrected (see Patent Literature 2: Japanese Patent Application Laid-Open No. 8-102586).

The following technique is also known instead of reading the γ correction patches using the image input unit. An image density control (IDC) sensor is provided near an intermediate transfer belt in an image forming apparatus. The IDC sensor reads γ correction patches formed on photoreceptors or the intermediate transfer belt to output measured values. The resulting measured values are compared with original densities of the γ correction patches for creating a γ correction table.

The following technique is also proposed. A color sensor is provided downstream of an image forming unit in an image forming apparatus. The color sensor reads a density correction chart (γ correction chart) formed on a sheet through the image forming unit to output measured values. A γ correction table is created by comparing the measured values with original densities of the γ correction chart. This technique using the color sensor can create the γ correction table based on the measured values of the image formed on the sheet. Accordingly, this technique can correct various characteristics ranging from transfer to fixation of the image forming apparatus for every type of sheet.

Meanwhile, the image stabilization control involves adjustment of process conditions, such as correction controls of the highest density, the surface potential of the photoreceptor, and the halftone density. This adjustment requires adaptation of the γ correction table so as to be fit to the adjusted process conditions.

Unfortunately, in the creation of the γ correction table using the color sensor, a sheet suitable for creation of the γ correction table is not always present in a paper feed tray when the image stabilization control ends. Furthermore, a γ correction chart is automatically output. Thus, image stabilization control during a job causes the γ correction chart to be mixed in prints, even if the sheet suitable for the correction is present in the paper feed tray. This phenomenon leads to imperfect collating, pages missing, and low productivity due to reworking. For these reasons, during conventional image stabilization control, the γ correction table is not recreated for printer γ correction suited for the adjusted process conditions in some cases.

### SUMMARY OF THE INVENTION

It is an object of the present invention to provide an image forming apparatus that can make printer γ correction suited for adjusted process conditions by image stabilization control through a color sensor process.

In order to attain at least one of the objects described above, according to an aspect of the present invention, there is provided an image forming apparatus including: an image forming unit forming an image on a sheet; a sensor reading the image formed on the sheet by the image forming unit; a density-correction-data generation unit generating density correction data by causing the sensor to read a density correction chart formed on the sheet by the image forming unit; a storage unit storing the generated density correction data in connection with a sheet type; a density correction unit reading the density correction data corresponding to the sheet type used for printing from the storage unit, and making density correction of image data to be printed based on the density correction data; an image stabilization control unit performing image stabilization control for adjusting process conditions of the image forming unit; and a regeneration control unit controlling the density-correction-data generation unit to regenerate the density correction data stored in the storage unit if the image stabilization control is performed.

Preferably, the regeneration control unit controls the density-correction-data generation unit to regenerate the density correction data corresponding to the sheet type used for the printing, and controls the density correction unit to make the density correction of the image data to be printed if the image stabilization control is performed.

Preferably, the regeneration control unit determines whether the image stabilization control is performed after the density correction data corresponding to the sheet type used for the printing is registered in the storage unit upon print instruction, and if determining that the image stabilization control is performed after the density correction data corresponding to the sheet type used for the printing is registered in the storage unit, the control unit controls the density-correction-data generation unit to regenerate the density correction data corresponding to the sheet type used for the printing.

Preferably, the image forming apparatus further includes a setting unit setting whether the density correction data stored in the storage unit is automatically regenerated if the image stabilization control is performed, wherein the regeneration control unit controls the density-correction-data generation unit to regenerate the density correction data stored in the storage unit only if the setting unit sets regeneration of the density correction data stored in the storage unit.

Preferably, the image forming apparatus further includes a display unit, wherein the regeneration control unit controls a screen for notifying a user of necessity of regeneration of the density correction data stored in the storage unit to be displayed on the display unit.

### BRIEF DESCRIPTION OF THE DRAWINGS

The present invention will be fully understood by the following detailed description and the accompanying drawings, which are not, however, intended to limit the present invention, wherein:

FIG. 1 is a schematic diagram illustrating a configuration of an image forming apparatus;

FIG. 2 is a functional block diagram of the image forming apparatus;

FIG. 3 shows a data storage structure of a nonvolatile memory;

FIG. 4 is a schematic diagram illustrating a configuration of a color sensor;

FIG. 5 shows size specifications of a γ correction chart;

FIG. 6 shows an example of the γ correction chart;

FIG. 7 shows an exemplary data structure of γ correction data;

FIG. 8 shows an exemplary data structure of sheet categories;

FIG. 9 shows an example of a specific setting screen;

FIG. 10 shows a data structure of tray paper profiles;

FIG. 11 shows an example of a setting screen for adjustment of the output-sheet density;

FIG. 12 shows an example of setting information on the adjustment of the output-sheet density;

FIG. 13 is a flowchart illustrating image stabilization and printer γ control processing executed by an image controlling CPU;

FIG. 14 shows an example of a screen for notifying a user of γ correction data necessary to regenerate as a result of image stabilization control; and

FIG. 15 is a flowchart illustrating printer γ automatic adjustment processing executed by the image controlling CPU.

### DETAILED DESCRIPTION OF THE PREFERRED EMBODIMENTS

A configuration and an operation of an image forming apparatus according to an embodiment of the present invention will be described in detail with reference to the accompanying drawings. While a color image forming apparatus is described by way of example in the embodiment, the present invention should not be limited to the color image forming apparatus and can also be applied to a monochrome image forming apparatus.

### [Configuration of Image Forming Apparatus 10]

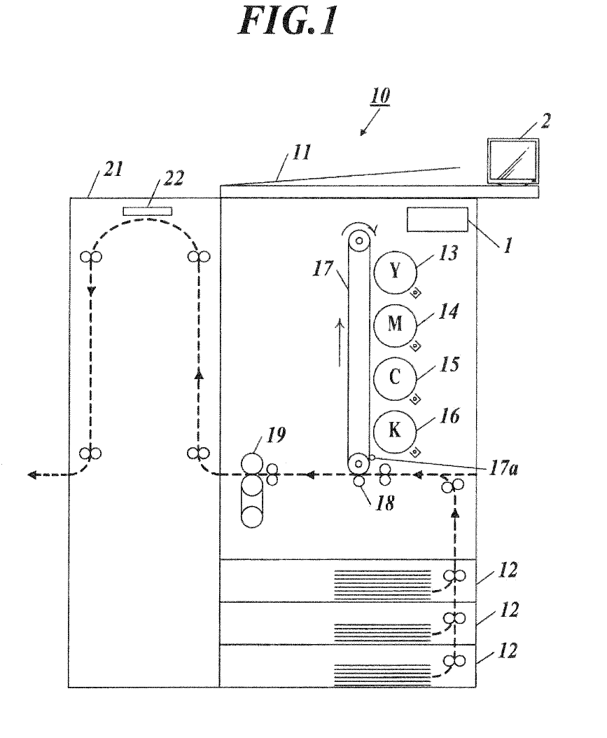

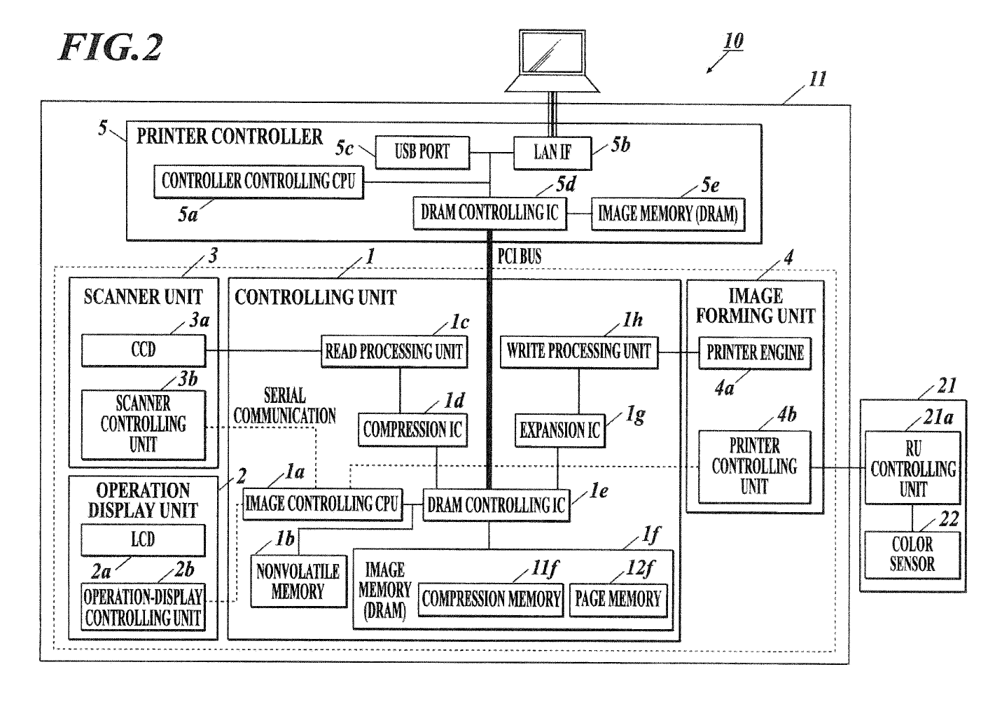

FIG. 1 illustrates a schematic configuration of an image forming apparatus 10. FIG. 2 is a functional block diagram of the image forming apparatus 10.

The image forming apparatus 10 is an electrophotographic digital printer and includes a main body 11 and a relay unit (hereinafter, “RU”) 21.

The main body 11 includes a control unit 1, an operation display unit 2, a scanner 3, an image forming unit 4, and a printer controller 5.

The control unit 1 includes an image controlling CPU 1a, a nonvolatile memory 1b, a read processing unit 1c, a compression IC 1d, a DRAM controlling IC 1e, an image memory 1f, an expansion IC 1g, and a write processing unit 1h.

The image controlling CPU 1a, which includes a CPU, a RAM, and a ROM, reads various programs stored in the ROM or the nonvolatile memory 1b, loads the read programs to the RAM, and executes various processes in cooperation with the loaded programs, thereby controlling the constituent units of the image forming apparatus 10. For example, the image controlling CPU 1a controls the constituent units of the image forming apparatus 10 in cooperation with the programs, thereby functioning as a density-correction data generation unit, a density correction unit, an image stabilization control unit, and a regeneration control unit.

The nonvolatile memory 1b, which is a rewritable nonvolatile memory, serves as a storage unit storing various programs and various pieces of data.

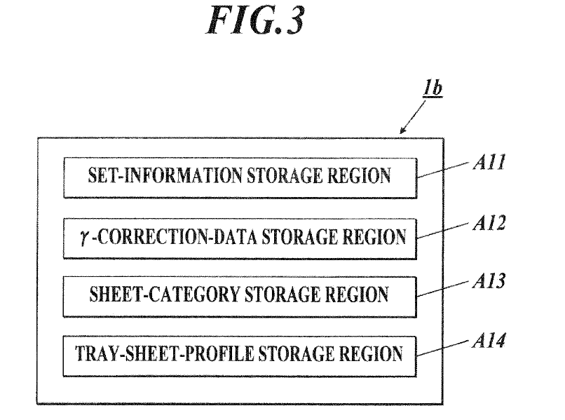

In the embodiment, as shown in FIG. 3, a set-information storage region A11, a γ-correction-data storage region A12, a sheet-category storage region A13, and a tray-sheet-profile storage region A14 are provided in the nonvolatile memory 1b, as data storage regions for adjustment of the output-sheet density to be described later.

The nonvolatile memory 1b also stores image data on density correction charts (hereinafter, “γ correction charts” to be described later in detail), size specifications, default correction values, and γ correction data by an IDC sensor, for example. The nonvolatile memory 1b further includes a total counter storing a count value, that is, the total number of prints in an image forming unit 4.

The read processing unit 1c receives analog image signals output from a CCD 3a, performs analog processing, shading processing, A/D conversion processing, or the like, on the input analog image signals, and generates digital image data. The read processing unit 1c outputs the generated image data to the compression IC 1d.

The compression IC 1d receives the image data output from the read processing unit 1c, compresses the input image data, and then outputs the compressed image data to the DRAM control IC 1e.

The DRAM control IC 1e controls the compression IC 1d to compress the image data read by the read processing unit 1c, and stores the compressed image data in a compression memory 11f.

The DRAM control IC 1e also receives the compressed image data from the compression memory 11f and controls the expansion IC 1g to expand the received image, and stores the expanded uncompressed image data in a page memory 12f. Furthermore, the DRAM control IC 1e receives uncompressed image data stored in the page memory 12f and outputs the input uncompressed image data to the write processing unit 1h.

The image memory 1f is a DRAM and includes the compression memory 11f and the page memory 12f. The compression memory 11f stores the compressed image data. The page memory 12f temporarily stores the uncompressed image data from which an image is to be formed, before forming the image.

The expansion IC 1g expands input compressed image data.

The write processing unit 1h generates printing data for forming an image based on the image data from which the image is to be formed and which is input from the DRAM control IC 1e, and outputs the printing data to the image formation unit 4.

The operation display unit 2 includes a liquid crystal display (LCD) 2a and an operation-display control unit 2b.

The LCD 2a serving as a display unit includes a touch panel that covers the LCD 2a. The operation-display control unit 2b receives display signals output from the image controlling CPU 1a and displays various setting screens on the LCD 2a in response to the input display signals. Furthermore, the operation-display control unit 2b receives operation signals generated by depression of operation keys (not shown) or the touch panel, and outputs the input operation signals to the image controlling CPU 1a.

The scanner 3 includes the CCD 3a and a scanner controlling unit 3b controlling the CCD 3a to be driven. The scanner 3 scans a surface of a document on a platen (not shown) while exposing the surface of the document with light from a light source, receives light reflected by the surface, and causes the CCD 3a to convert the received reflected light to analog image signals. The scanner 3 outputs the generated analog image signals to the read processing unit 1c.

The image forming unit 4 includes a printer engine 4a and a printer control unit 4b controlling the printer engine 4a to perform image forming operation.

The printer engine 4a includes a paper feed unit 12, photoreceptor drums 13 to 16, an intermediate transfer belt 17, a transfer roller 18, and a fixing device 19, as shown in FIG. 1. The printer engine 4a performs a series of image forming processes for forming a toner image on a sheet and fixing the formed toner image. An image density control (IDC) sensor 17a is provided downstream in a rotational direction of the intermediate transfer belt 17.

The paper feeding unit 12 includes a plurality of feeding trays for storing different types of sheets, respectively, and feeds these sheets to a predetermined transfer path.

The photoreceptor drums 13 to 16 form and carry toner images of respective colors of Y, M, C, and K thereon and transfer the toner images onto the intermediate transfer belt 17 (primary transfer).

The intermediate transfer belt 17 rotates while carrying the toner images formed by the (primary) transfer.

The transfer roller 18 transfers the toner images of the respective colors of Y, M, C, and K carried on the intermediate transfer belt 17 onto a sheet (secondary transfer).

The fixing device 19 heats or presses the toner images of the respective colors of Y, M, C, and K formed by the (secondary) transfer on the sheet and fixes the toner images onto the sheet. The sheet onto which the toner images are fixed is then transported to the RU 2.

The IDC sensor 17a is provided downstream in the rotational direction of the intermediate transfer belt 17. The IDC sensor 17a reads a γ correction chart formed on the intermediate transfer belt 17 and outputs the resulting voltage value to the image controlling CPU 1a.

The printer controller 5 includes a controller controlling CPU 5a, a LAN IF 5b, a USB port 5c, a DRAM control IC 5d, and an image memory 5e.

The controller controlling CPU 5a comprehensively controls operations of the respective constituent units of the printer controller 5.

The LAN IF 5b is a communication interface such as an NIC or a modem for connecting the image forming apparatus 10 to a LAN and receives image data transmitted from an external PC via the LAN. The LAN IF 5b also outputs the received image data to the DRAM control IC 5d.

The USB port 5c receives various pieces of data stored in a USB memory (not shown) and outputs the input data to the controller controlling CPU 5a.

The DRAM control IC 5d outputs the image data to the image memory 5e and receives image data from the image memory 5e. The DRAM control IC 5d is connected to the DRAM control IC 1e of the control unit 1 by a PCI bus and outputs the image data or various data to the DRAM control IC 1e.

The image memory 5e is a DRAM and temporarily stores the image data.

The RU 21 includes an RU control unit 21a and a color sensor 22. The RU 21 further includes a function to be synchronized with a transport speed of the sheet transported from the main body 11. Alternatively, the RU 21 may include so-called finisher functions capable of performing various processes such as punching, folding, paste application, cutting, and the like.

The RU control unit 21a, which includes a CPU, a RAM, and a ROM, reads various programs stored in the ROM, loads the programs to the RAM, and controls the constituent units of the RU 21 in cooperation with the programs. The RU control unit 21a is connected to the image controlling CPU 1a of the control unit 1 via the printer control unit 4b so as to be in data communication with the image controlling CPU 1a.

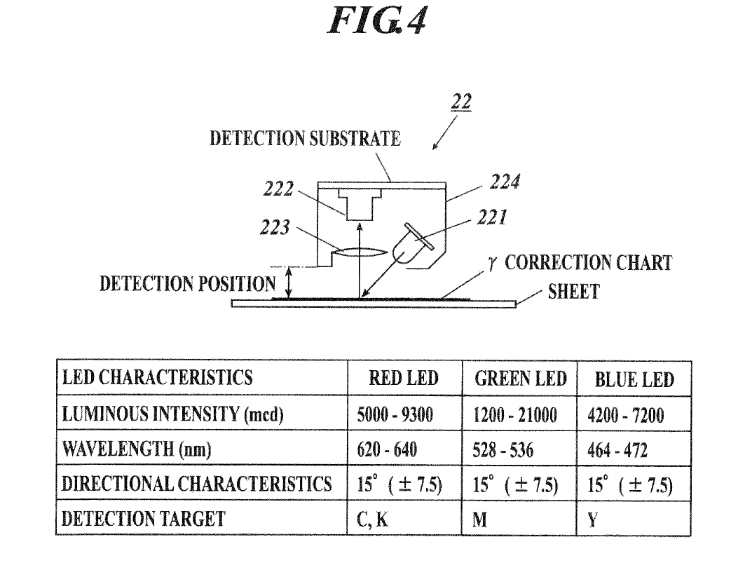

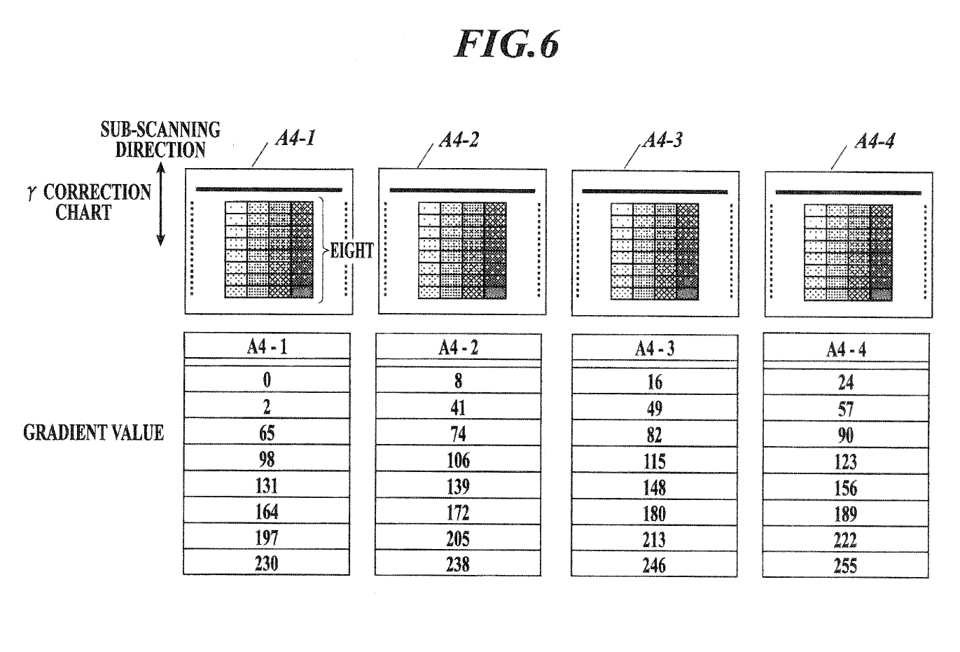

As shown in FIG. 4, the color sensor 22 is a reflection sensor including an LED light source 221, a light-receiving element 222, a lens 223, and a lens holder 224. The color sensor 22 reads the γ correction chart (see FIG. 6) formed on the sheet traveling by the sensor 22 and outputs the resulting voltage value to the RU control unit 21a.

### [Printer γ Correction]

As described above, the image forming apparatus 10 includes the IDC sensor 17a and the color sensor 22 and can make printer γ corrections by two processes, i.e., an IDC sensor process and a color sensor process.

The IDC sensor process involves correction of transfer characteristics of the image forming unit 4. In the IDC sensor process, the γ correction chart for the IDC sensor 17a is formed on the intermediate transfer belt 17, and the IDC sensor 17a measures colors, generates density correction data (hereinafter, “γ correction data”), and makes printer γ correction during a job for printing based on this γ correction data. The image forming apparatus 10 generates five types of γ correction data depending on screens.

The color sensor process involves correction of characteristics ranging from transfer to fixation of the image forming unit 4. In the color sensor process, characteristics inherent in sheets to be used are also corrected. In the color sensor process, the image forming unit 4 generates a γ correction chart (see FIG. 6) on the sheet, and the color sensor 22 of the RU 21 measures colors, generates γ correction data, and makes printer γ correction during forming an image based on this γ correction data. The image forming apparatus 10 generates 15 types of γ correction data depending on combinations of screens and sheet types (three types of plain paper, high-quality paper, and enamel paper in the embodiment). Processing for generating the γ correction data using this color sensor 22 is referred to as an “adjustment of the output-sheet density”. The adjustment of the output-sheet density is described next in detail.

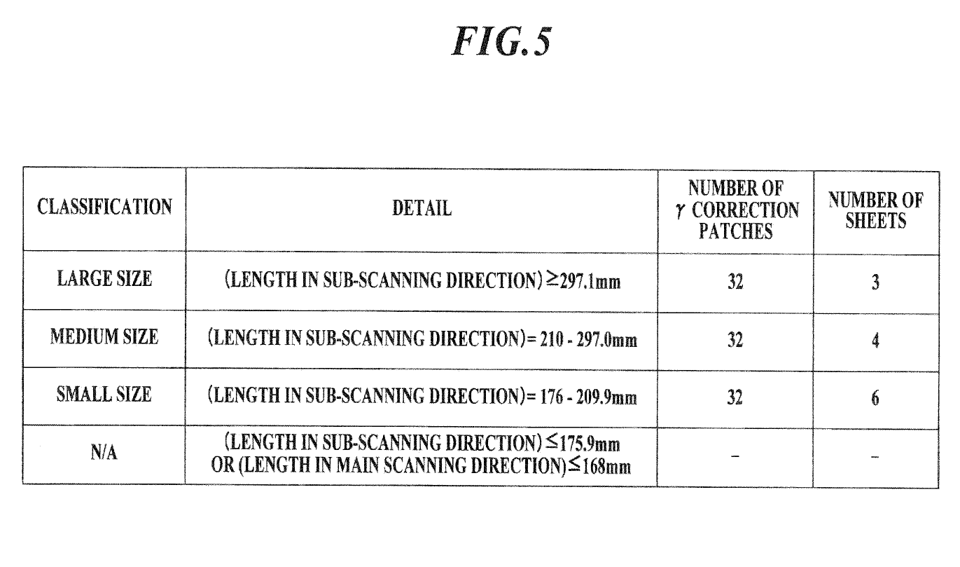

FIG. 5 shows size specifications of the γ correction charts used in the adjustment of the output-sheet density.

It is assumed that settings of the size specifications of the γ correction charts are stored in the nonvolatile memory 1b in advance. Each γ correction chart is composed of a plurality of γ correction patches which are formed over a plurality of sheets. Note that the sizes of the γ correction patches are determined by performances of the color sensor 22. In general, a larger sheet size leads to a decreased number of sheets used for the γ correction chart, while a smaller sheet size leads to a larger number of sheets. In the embodiment, the number of sheets necessary for the γ correction chart corresponds to three sheet sizes, that is, a large size, a medium size, and a small size. For example, if the γ correction chart is formed on an A4 sheet of 297.0 mm in length in a sub-scanning direction (sheet transport direction), the sheet is “medium size” and “the number of γ correction patches” is 32 and “the number of sheets” is four, accordingly.

FIG. 6 shows an example of the γ correction charts used in the adjustment of the output-sheet density.

Each of the γ correction charts shown in FIG. 6 is formed on an A4 sheet. The γ correction patches of colors Y, M, C, and K are formed on four A4 sheets A4-1 to A4-4. Eight γ correction patches are formed per A4 sheet and 32 γ correction patches are formed in total for the four A4 sheets. The total number of γ correction patches of the colors Y, M, C, and K are 32×4=128. As shown in FIG. 6, gradient values of the γ correction patches on the γ correction charts formed on the A4 sheets A4-1 to A4-4 spread all uniformly over the A4 sheets A4-1 to A4-4 with a gradient value of 255 set as a maximum value. Uniformly spreading density over the sheets can ensure color reproducibility and reduce chart dependence or noise.

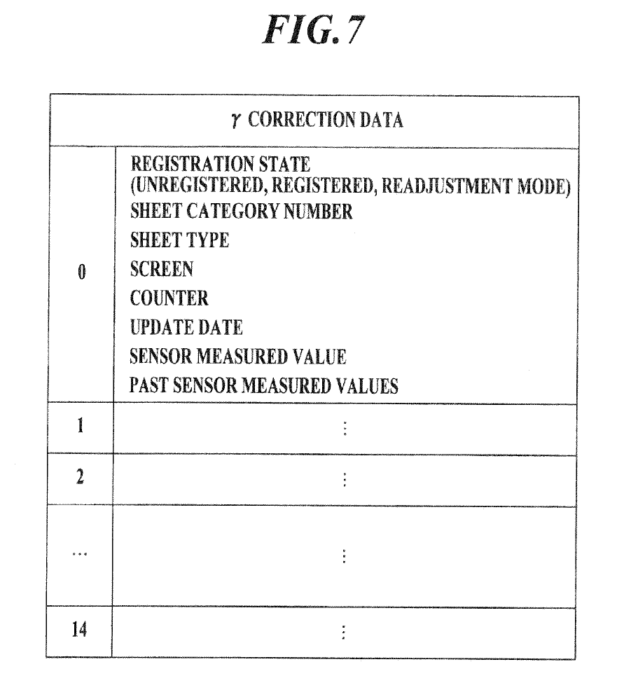

FIG. 7 shows an exemplary data structure of the γ correction data generated in the adjustment of the output-sheet density according to the embodiment. The γ correction data is used for creating a γ correction table and includes the measured values (densities) obtained by reading the γ correction charts by the color sensor 22. As shown in FIG. 7, the γ correction data includes such items as “registration state”, “sheet category number”, “sheet type”, “screen”, “counter”, “update date”, “sensor measured value”, and “past sensor measured values”.

The “registration state” stores one of the registration states, i.e., unregistered, registered, and readjustment modes. The unregistered state indicates that no sensor measured value is registered. The registered state indicates that a sensor measured value is registered. The readjustment mode indicates necessity of regeneration of a sensor measured value after the image stabilization control.

A registration number for a sheet category (sensor correction data of the color sensor 22) used for conversion of the voltage value output from the color sensor 22 to a density is stored in a storage region corresponding to the item. “sheet category number”. The sheet category will be described later in detail.

Information indicating a sheet type corresponding to the γ correction data is stored in a storage region corresponding to the item “sheet type”.

Information indicating a screen type corresponding to the γ correction data is stored in a storage region corresponding to the item “screen”.

Information indicating a total count (the total number of prints) in the image forming apparatus 10 at the time of registration of the sensor measured value is stored in a storage region corresponding to the item “counter”.

Information indicating the update date of the γ correction data is stored in a storage region corresponding to the item “update date”.

The value converted from the voltage value obtained after the color sensor 22 measures colors of the γ correction chart during the adjustment of the output-sheet density is stored in a storage region corresponding to the item “sensor measured value”.

The sensor measured values before update is stored in a storage region corresponding to the item “past sensor measured values”. A γ correction table or function used for the printer γ correction is created from these sensor measured values.

This γ correction data is stored in the γ-correction-data storage region A12 of the nonvolatile memory 1b.

The sheet category is now described.

The output-sheet density is adjusted by causing the color sensor 22 to read the γ correction chart formed on each sheet. In order to obtain images of stable quality, it is necessary to correct reading characteristics of the color sensor 22 changed with changes inherent in the color sensor 22 such as replacement of the color sensor 22 and positional deviation thereof. Accordingly, a sensor characteristic correction is made to obtain the value obtained by causing the color sensor 22 to read the γ correction chart formed on the sheet transported from the sheet feed unit 12 and densities such as XYZ tristimulus values obtained by causing a colorimeter (not shown) to read the γ correction chart. The values are stored in the sheet-category storage region A13 of the nonvolatile memory 1b as the sensor correction data. Since this sensor correction data depends on a sheet, the data is referred to as “sheet category”. Based on the sheet category, a density conversion table or function is created for converting a voltage value obtained by the sensor into a density, and the γ correction data is created using this density conversion table or function.

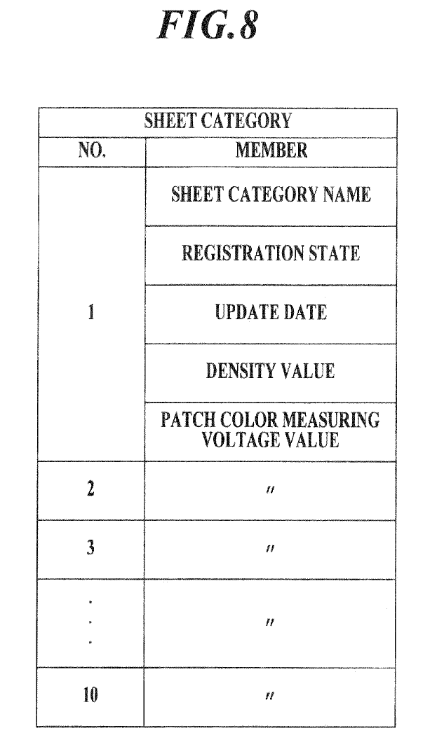

FIG. 8 shows an exemplary data structure of sheet categories. As shown in FIG. 8, each sheet category includes a “patch color-measuring voltage value” that is the voltage value obtained by causing the color sensor 22 to read the γ correction chart formed on the sheet and “densities” that are such densities as XYZ tristimulus values obtained by causing the colorimeter to read the γ correction chart. For example, ten sheet categories No. 1 to No. 10 can be registered in the sheet-category storage region A13. By creating the density conversion table or function indicating the relation between the voltage value output from the color sensor 22 and the densities such as the XYZ tristimulus values based on the sheet category, characteristics of the color sensor 22 can be corrected.

Note that the nonvolatile memory 1b stores default sensor correction data (hereinafter, “default correction values”) and the default correction values can be used during the printer γ correction.

The sheet categories and default correction values are associated with (linked to) sheet settings of the respective paper feed trays. During the adjustment of the output-sheet density, the γ correction data is generated using the sheet category or default correction value associated with the sheet setting of the paper feed tray in which the adjustment of the output-sheet density target sheet is set.

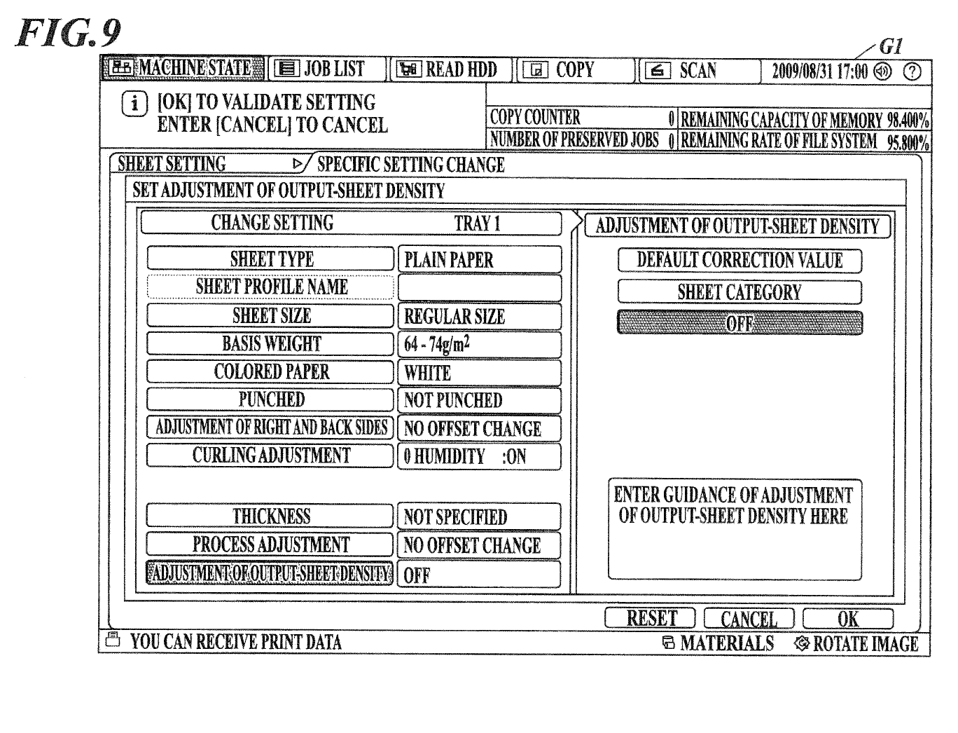

The sheet category or default correction value can be associated with the sheet setting of each paper feed tray on a setting screen G1 for each tray shown in, for example, FIG. 9. Specifically, if a setting screen G1 for a desirable tray is displayed on the LCD 2a of the operation display unit 2 and an “adjustment of the output-sheet density” button is pressed, a “default correction value” button, a “sheet category” button, and an “OFF” button are displayed in a right region of the screen G1. When the “default correction value” button is pressed, the default correction value is associated with the sheet set in the target tray. When the “sheet category” button is pressed, a list of registered sheet categories is displayed and the sheet category selected from the list is associated with the sheet set in the target tray. When the “OFF” button is pressed, the γ correction according to the IDC sensor process is associated with the sheet.

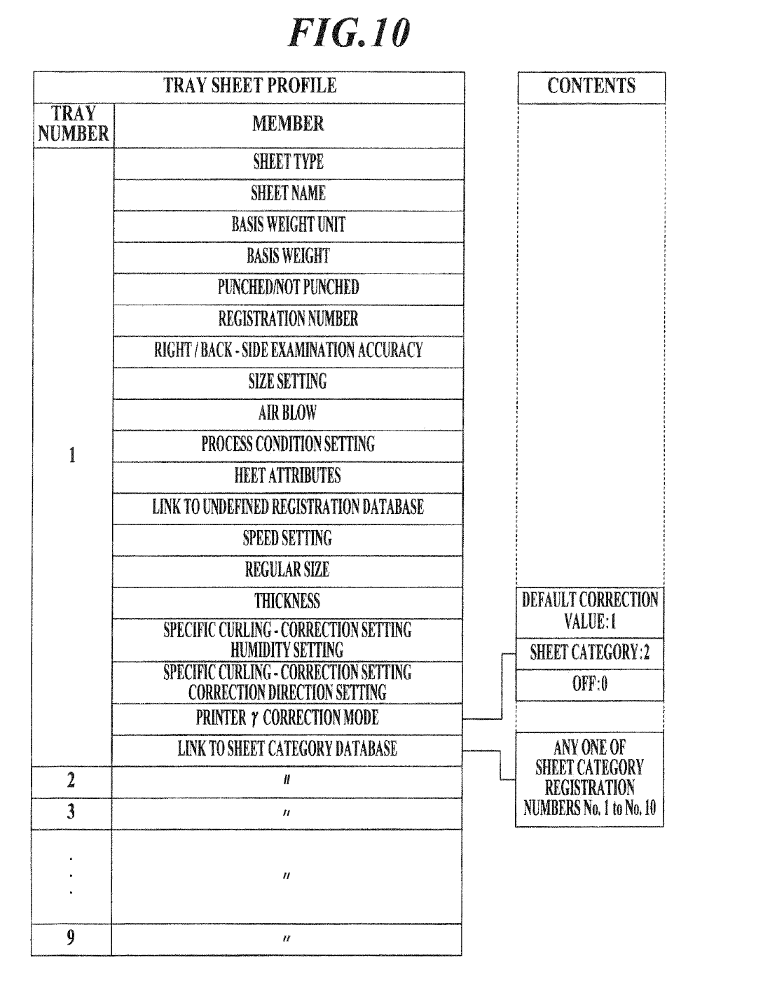

The nonvolatile memory 1b includes the tray-sheet-profile storage region A14 for storing tray sheet profiles. Each tray sheet profile is setting information on sheets stacked in each paper feed tray of the paper feed unit 12 of the image forming apparatus 10. FIG. 10 shows an exemplary data structure of tray sheet profiles. By setting a “printer γ correction mode” in the tray sheet profile of the target tray stored in this tray-sheet-profile storage region A14 to a content corresponding to the pressed button, the printer γ correction process according to the pressed button for the target tray is associated with the sheet. If a printer correction mode is set to “2”, the sheet is linked to the selected sheet category by setting the registration number of the selected category to a “link to sheet-category database”.

### [Preparation of Adjustment of the Output-Sheet Density]

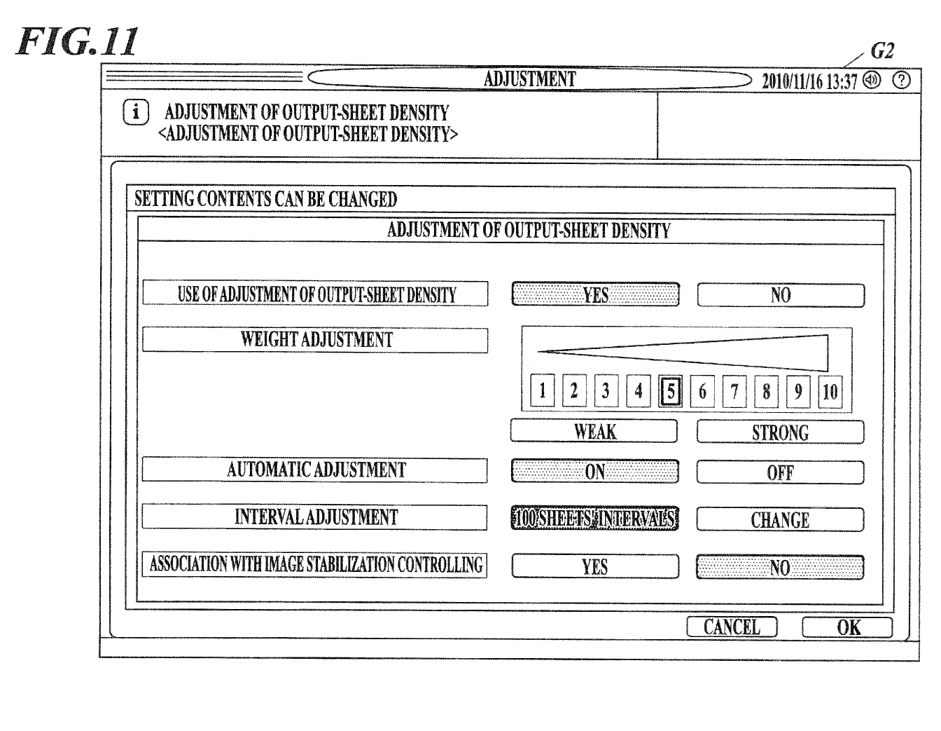

For the adjustment of the output-sheet density, the adjustment of the output-sheet density must be activated on a setting screen G2 for output-sheet-density adjustment. FIG. 11 shows an example of the setting screen G2 for output-sheet-density adjustment. The setting screen G2 for output-sheet-density adjustment is a screen serving as a setting unit performing various settings relating to the adjustment of the output-sheet density. This setting screen G2 for output-sheet-density adjustment is displayed in response to a predetermined operation with the operation display unit 2.

As shown in FIG. 11, operation buttons for settings of such items as “use of adjustment of the output-sheet density”, “weight adjustment”, “automatic adjustment”, “interval adjustment”, and “association with image stabilization control” are provided on the setting screen G2 for output-sheet-density adjustment.

The “use of adjustment of the output-sheet density” is an item for setting whether the adjustment of the output-sheet density is used or not. If a “YES” button is pressed, the adjustment of the output-sheet density is set to be usable. If a “NO” button is pressed, the adjustment of the output-sheet density is set to be unusable. In this case, the entire printer γ correction is made by the IDC sensor process. In default configuration, “NO” is selected. If the item “use of adjustment of the output-sheet density” is “NO”, the subsequent items are shaded and cannot be set.

The “automatic adjustment” is an item for setting whether to automatically execute the adjustment of the output-sheet density. If an “ON” button is pressed, the adjustment of the output-sheet density is set to be automatically executed at intervals set by the “interval adjustment”. If an “OFF” button is pressed, the adjustment of the output-sheet density is set not to be automatically executed but manual adjustment can be executed. If the “OFF” button is pressed for the item “automatic adjustment”, the subsequent items are shaded and cannot be set.

The “interval adjustment” is an item for setting the timing of automatic correction. The adjustment of the output-sheet density is set to be automatically executed after a given number of sheets set by this item are subjected to printing. Pressing a “CHANGE” button can set the interval adjustment within the range of 100 to 99,999.

The “weight adjustment” is an item for giving a γ-correction weight in accordance with the adjustment of the output-sheet density. The weight adjustment can beset in the range of one to ten.

The “association with image stabilization control” is an item for setting whether the output-sheet density is automatically adjusted in response to the image stabilization control after the image stabilization control. If a “YES” button is pressed, the adjustment of the output-sheet density associated with the image stabilization control is set to be automatically executed. If a “NO” button is pressed, the adjustment of the output-sheet density associated with the image stabilization control is set not to be automatically executed.

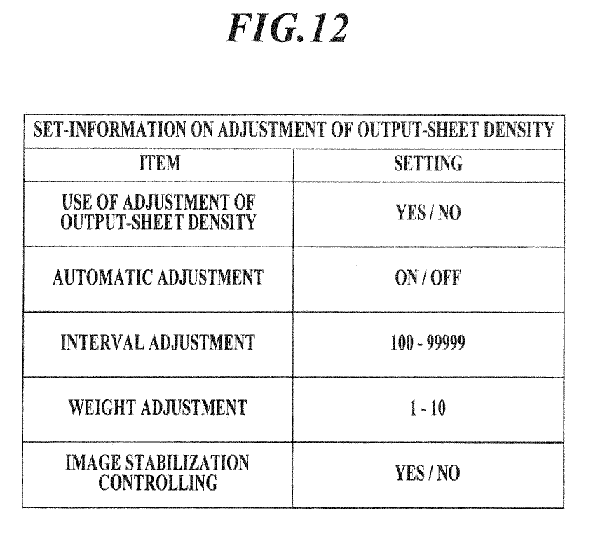

The information set on the setting screen G2 for output-sheet-density adjustment is stored in the set-information storage region A11 of the nonvolatile memory 1b. FIG. 12 shows a data structure of the set information stored in the set-information storage region 11.

### [Image Stabilization Control and Adjustment of the Output-Sheet Density]

The relation between the image stabilization control and the adjustment of the output-sheet density is described.

The image stabilization control is control for stably supplying images with respect to changes in environmental factors such as internal temperature and humidity of the image forming apparatus 10 or to developer replacement. The image stabilization control is executed mainly at the following timing.

1) If an idling state continues for six hours or more,
2) If a predetermined number of sheets are subjected to printing after previous image stabilization control is executed,
3) If the internal temperature and humidity change by 20 percent or more since the previous image stabilization control is executed in a power-ON state, and
4) If developer is replaced.

In the image stabilization control, a highest density adjustment, a uniform correction to surface potentials of the photoreceptors and a halftone density correction, for example, are carried out. In the highest density adjustment, a developing DC bias is adjusted. In the surface potential uniform correction, a grid voltage is adjusted. In the halftone density correction, highest laser power is adjusted. Adjusting these process conditions is intended to electrically correct hardware-related change factors. Due to this, after the image stabilization control, it is necessary to generate γ correction data fit to the adjusted process conditions.

However, for generation of the γ correction data for the color sensor process, that is, for the adjustment of the output-sheet density, that sheets for the adjustment of the output-sheet density are must be set in one of the paper feed trays of the paper feed unit 12. The problem is that the target sheet is not always set in one of the paper feed trays at the end of the image stabilization control. If the image stabilization control is performed during a job, then the γ correction chart is mixed in prints, imperfect collating and pages missing possibly occur, and productivity is possibly reduced due to reworking. Due to this, the output-sheet density cannot be adjusted at the end of the image stabilization control according to the color sensor process differently from the IDC sensor process.

Therefore, the image forming apparatus 10 is controlled so that image stabilization and printer γ control processing to be described later is executed at the time of the image stabilization control and so that γ correction data is regenerated if a print command is issued in a job after the end of the image stabilization control. Specifically, the registration state of the registered γ correction data is set to “readjustment mode”. Furthermore, the printer γ automatic processing described as follows is executed following a job for printing. If the registration state of the γ correction data corresponding to the sheet type and screen used for printing during the job is the “readjustment mode”, γ correction data fit for the adjusted process conditions after the image stabilization control is regenerated by regenerating the γ correction data.

### [Image Stabilization and Printer γ Control Processing]

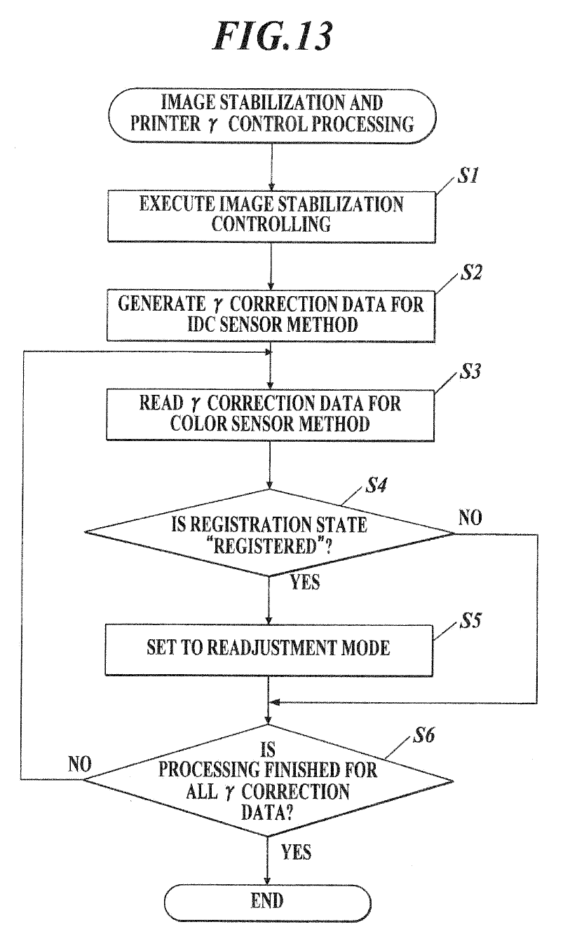

FIG. 13 shows a flowchart of the image stabilization and printer γ control processing executed by the image controlling CPU 1a of the control unit 1 following execution of the image stabilization control. The image controlling CPU 1a executes this processing in cooperation with the programs stored in the image controlling CPU 1a and the nonvolatile memory 1b.

First, the image controlling CPU 1a controls the image forming unit 4 to execute the image stabilization control (Step S1).

Next, the image controlling CPU 1a controls the image forming unit 4 to generate the γ correction data for the IDC sensor process (Step S2). Specifically, the γ correction chart is formed on the intermediate transfer belt 17 and the IDC sensor 17a measures colors. The voltage value obtained as a result of color measuring is converted to the density using the correction data acquired by correcting the sensor characteristics of the IDC sensor 17a and the density is stored in the nonvolatile memory 1b as the γ correction data.

The γ correction data for the color sensor process stored in the nonvolatile memory 1b is read one by one (Step S3), and the image controlling CPU 1a determines whether the registration state of the γ correction data is “registered” (Step S4). If the registration state of the γ correction data is “registered” (Step S4; Y), the registration state is set to the “readjustment mode” (Step S5) and the processing is shifted to a step S6. If the image controlling CPU 1a determines that the registration state is not “registered” (Step S4; N), the processing is shifted to step S6.

In step S6, the image controlling CPU 1a determines whether the processing in and after step S3 is finished for all the γ correction data stored in the nonvolatile memory 1b. If the processing is not finished (Step S6; N), the processing returns to step S3 and the processing in and after step S3 is executed for γ correction data that is not read yet. If the processing in and after step S3 is finished for all the γ correction data stored in the nonvolatile memory 1b (Step S6; Y), the image stabilization and printer γ control processing is finished.

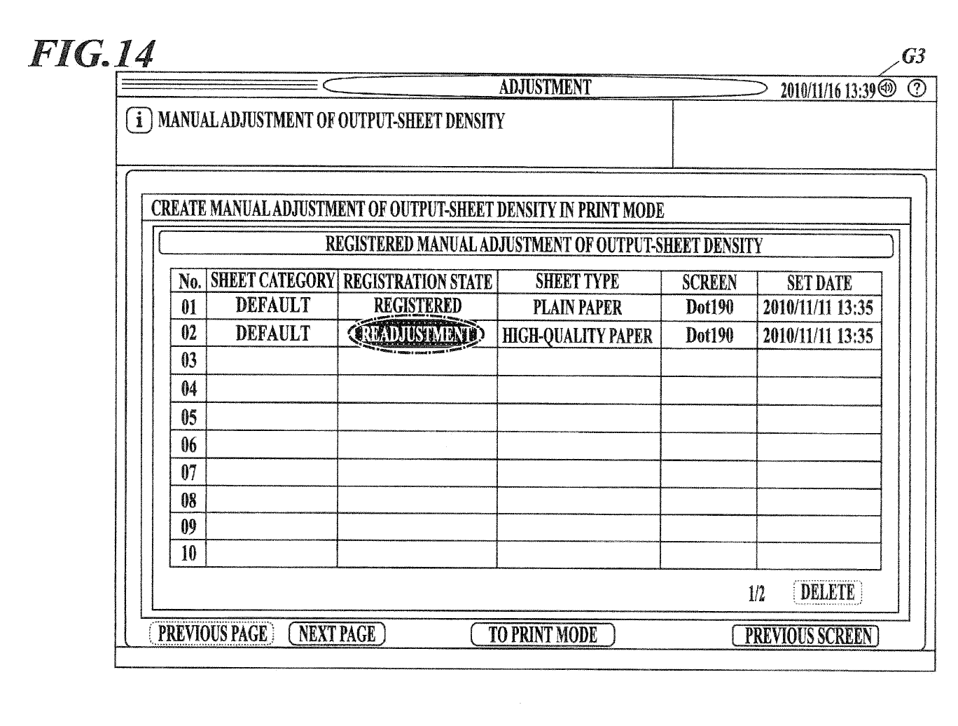

As shown in FIG. 14, in the image stabilization and printer γ control processing, it is preferable that a screen G3 showing a list of read γ correction data is displayed on the LCD 2a, data the registration state of which is “readjustment” is highlighted, and a user is notified of the γ correction data necessary to regenerate as a result of the image stabilization control. By doing so, the user recognizes the need to regenerate the γ correction data and can be promoted to regenerate the γ correction. Due to this, even if automatic adjustment of the output-sheet density is set OFF or the association with the image stabilization control is set OFF, γ correction data fit for the adjusted process conditions can be regenerated.

### [Printer γ Automatic Adjustment Processing]

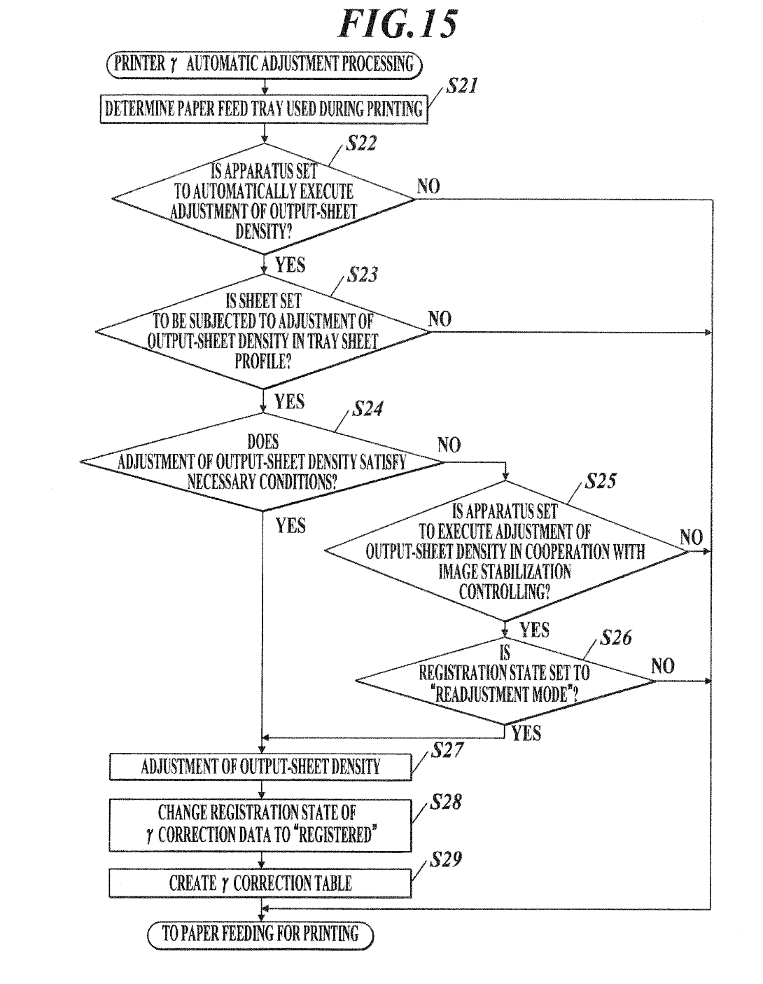

FIG. 15 is a flowchart of the printer γ automatic adjustment processing executed by the image controlling CPU 1a of the control unit 1. The image controlling CPU 1a executes this processing in cooperation with the programs stored in the image controlling CPU 1a and the nonvolatile memory 1b following execution of a job on a print command.

Upon the determination of the paper feed tray used during printing based on the job (paper feed tray in which the sheets used for printing are stacked) (Step S21), the image controlling CPU 1a determines whether the image forming apparatus 10 is set to automatically execute the adjustment of the output-sheet density with reference to the setting information on the adjustment of the output-sheet density stored in the nonvolatile memory 1b (Step S22). If the image controlling CPU 1a determines that the image forming apparatus 10 is not set to automatically execute the adjustment of the output-sheet density (Step S22; N), the processing is finished and the step goes to paper feeding for printing based on the job.

If the image controlling CPU 1a determines that the image forming apparatus 10 is set to automatically execute the adjustment of the output-sheet density (Step S22; Y), the image controlling CPU 1a determines whether the sheet set in the paper feed tray is set to be subjected to the adjustment of the output-sheet density with reference to the tray sheet profile of the paper feed tray used during printing (Step S23). Specifically, if the printer γ correction mode in the sheet profile of the paper feed tray used during printing is “1: Default correction value” or “2: Sheet Category”, the image controlling CPU 1a determines that the sheet set in the paper feed tray is set to be subjected to the adjustment of the output-sheet density.

If the image controlling CPU 1a determines that the sheet set in the paper feed tray is not to be subjected to the adjustment of the output-sheet density by referring to the tray sheet profile (Step S23; N), this processing is finished and the step goes to paper feeding for printing based on the job. If the image controlling CPU 1a determines that the sheet set in the paper feed tray is to be subjected to the adjustment of the output-sheet density by referring to the tray sheet profile (Step S23; Y), the image controlling CPU 1a determines whether the adjustment of the output-sheet density satisfies necessary conditions (Step S24). For example, if the γ correction data corresponding to the combination of the sheet type and screen used for printing is not stored in the nonvolatile memory 1b or if the γ correction data is stored but printing is performed on the sheets in number equal to or greater than that set as the interval adjustment since the previous adjustment of the output-sheet density (the value obtained by subtracting the count value of the γ correction data from the total number is equal to or greater than the number set as the interval adjustment), it is determined that the adjustment of the output-sheet density does not satisfy the necessary conditions.

If the adjustment of the output-sheet density does not satisfy the necessary conditions (Step S24; N), the image controlling CPU 1a determines whether the image forming apparatus 10 is set to execute the adjustment of the output-sheet density in cooperation with the image stabilization control while referring to the setting information on the adjustment of the output-sheet density stored in the nonvolatile memory 1b (Step S25). If the image forming apparatus 10 is not set to execute the adjustment of the output-sheet density in cooperation with the image stabilization control (Step S25; N), this processing is finished and the step goes to paper feeding for printing based on the job.

If the image forming apparatus 10 is set to execute the adjustment of the output-sheet density in cooperation with the image stabilization control (Step S25; Y), the image controlling CPU 1a determines whether the registration state of the γ correction data corresponding to the combination of the sheet type and screen used for printing, stored in the nonvolatile memory 1b, is “readjustment mode” (Step S26). If the registration state is not the “readjustment mode” (Step S26; N), this processing is finished and the step goes to paper feeding for printing based on the job.

If the registration state is the “readjustment mode” (Step S26; Y), the adjustment of the output-sheet density is executed (Step S27). In the adjustment of the output-sheet density, the sheet is fed from the paper feed tray used for printing and the image forming unit 4 forms an image of the γ correction chart on the sheet. Subsequently, the color sensor 22 reads the γ correction chart formed on the sheet to obtain the voltage that is the result of the color measurement. Then, using the linked sheet category in the tray sheet profile of the paper feed tray used for the present printing (default correction value in the case of the default correction value), the voltage value is converted to the density value and the γ correction data of the combination of the sheet type and screen used for printing is updated with the obtained density set as the sensor measured value.

After the end of the adjustment of the output-sheet density, the registration state of the γ correction data of the combination of the sheet type and screen used for printing is changed to “registered” (Step S28). Using the updated γ correction data, the printer γ correction table (γ correction table) or function is created (Step S29) and the processing is finished. In step S29, the density of the γ correction data is compared with data on the density of the γ correction chart itself, for example, and the γ correction table or function cancelling the difference is created. After the end of this processing, paper feeding starts for printing based on the job under the control of the image controlling CPU 1a. In addition, the image data to be printed is subjected to printer γ correction using the generated γ correction table or function, and the image forming unit 4 forms an image on the sheet based on the corrected image data.

As described above, the image controlling CPU 1a of the image forming apparatus 10 controls the γ correction data stored in the nonvolatile memory 1b to be regenerated after the image stabilization control is executed. Specifically, the registration state of the γ correction data stored in the nonvolatile memory 1b is set to the “readjustment mode”. During printing, the image controlling CPU 1b determines whether the registration state of the γ correction data corresponding to the sheet type used for printing is set to the “readjustment mode”. If the registration state is the “readjustment mode”, the image controlling CPU 1a adjusts the output-sheet density to regenerate the γ correction data, creates the γ correction table or function using the regenerated γ correction data, and makes the printer γ correction of the image data.

Accordingly, the image forming apparatus making the printer γ correction based on the color sensor process can make the γ correction fit for the adjusted process conditions by the image stabilization control. As a result, it is possible to prevent a change in the image quality due to the printer γ correction that is not fit for the adjusted process conditions by the image stabilization control and reduction in the productivity due to reworking following the changed image quality.

Moreover, upon the image stabilization control, the output-sheet density is adjusted for the sheet type used in printing before paper feeding for printing based on the job and the γ correction data corresponding to the sheet type is regenerated. This can prevent the γ correction chart from being mixed into the sheets during the job. Furthermore, the printer γ correction can be made using the γ correction data generated according to the apparatus characteristics during the printing.

Furthermore, after regeneration of the γ correction data, the registration state is returned to “registered”. The image controlling CPU 1a thereby controls the γ correction data to be regenerated only during the image stabilization control after registration of the present γ correction data in the nonvolatile memory 1b. This can suppress unnecessary adjustment of the output-sheet density.

Moreover, the image controlling CPU 1a controls the output-sheet density to be automatically adjusted and the γ correction data to be regenerated only if the image forming apparatus 10 is set to automatically adjust the output-sheet density during the image stabilization control. Thus, the user can adjust the output-sheet density at any timing by setting the adjustment to a manual mode, if necessary.

Furthermore, upon the image stabilization control, the image controlling CPU 1a displays a message to prompt the user to regenerate the γ correction data stored in the nonvolatile memory 1b on the LCD 2a. The user thus can recognize necessity of regeneration of the γ correction data. As a result, if manual adjustment is set for the output-sheet density, it is possible to prevent a change in the image quality caused by printing without user's awareness on the need to regenerate the γ correction data or a reduction in the productivity due to the reworking for recovering the changed image quality.

It is to be noted that the description of the embodiment is intended to show a preferred example of the image forming apparatus according to the present invention and that the present invention is not limited to the embodiment.

For example, the timing of displaying the screen for notifying the user of the γ correction data necessary to be readjusted after the image stabilization control is not limited to that described in the embodiment. For example, the screen may be displayed when it is determined that the image forming apparatus is not set to adjust the output-sheet density in an interlocking manner with the image stabilization control.

Moreover, in the embodiment, the use of the ROM, nonvolatile memory, or hard disk as a computer-readable medium for a program according to the present invention is disclosed by way of example. The present invention is however not limited to this example. A portable recording medium such as a CD-ROM can be used as any other computer-readable medium. Furthermore, carrier waves (carriers) can be applied as a medium for providing data on the program according to the present invention via a communication line.

Additionally, detailed configurations and detailed operations of the respective units or devices can be appropriately modified without departure of the spirit of the present invention.

The entire disclosure of Japanese Patent Application No. 2010-285362 filed on Dec. 22, 2010 including description, claims, drawings, and abstract are incorporated herein by reference in its entirety.

What is claimed is:

1. An image forming apparatus comprising:
an image forming unit forming an image on a sheet;
a sensor reading the image formed on the sheet by the image forming unit;
a density-correction-data generation unit generating density correction data by causing the sensor to read a density correction chart formed on the sheet by the image forming unit;
a storage unit storing the generated density correction data in connection with a sheet type;
a density correction unit reading the density correction data corresponding to the sheet type used for printing from the storage unit, and making density correction of image data to be printed based on the density correction data;
an image stabilization control unit performing image stabilization control for adjusting process conditions of the image forming unit; and
a regeneration control unit controlling the density-correction-data generation unit to regenerate the density correction data stored in the storage unit if the image stabilization control is performed.

2. The image forming apparatus according to claim 1, wherein
the regeneration control unit controls the density-correction-data generation unit to regenerate the density correction data corresponding to the sheet type used for the printing, and controls the density correction unit to make the density correction of the image data to be printed if the image stabilization control is performed.

3. The image forming apparatus according to claim 2, wherein
the regeneration control unit determines whether the image stabilization control is performed after the density correction data corresponding to the sheet type used for the printing is registered in the storage unit upon print instruction, and if determining that the image stabilization control is performed after the density correction data corresponding to the sheet type used for the printing is registered in the storage unit, the control unit controls the density-correction-data generation unit to regenerate the density correction data corresponding to the sheet type used for the printing.

4. The image forming apparatus according to claim 1, further comprising a setting unit setting whether the density correction data stored in the storage unit is automatically regenerated if the image stabilization control is performed, wherein
the regeneration control unit controls the density-correction-data generation unit to regenerate the density correction data stored in the storage unit only if the setting unit sets regeneration of the density correction data stored in the storage unit.

5. The image forming apparatus according to claim 1, further comprising a display unit, wherein
the regeneration control unit controls a screen for notifying a user of necessity of regeneration of the density correction data stored in the storage unit to be displayed on the display unit.
